(19) United States
(12) Patent Application Publication
(10) Pub. No.: US 2026/0212479 A1
(43) Pub. Date: Jul. 23, 2026

(54) METHOD AND SYSTEM FOR INSPECTION OF DEFECTS IN SEMICONDUCTOR FABRICATION

(71) Applicant: Onto Innovations Inc., Wilmington, MA (US)

(72) Inventors: ManJun Lee, San Ramon, CA (US); Jatinder Dhaliwal, Plano, TX (US); Chien-Wen Chen, Taichung City (TW)

(73) Assignee: Onto Innovations Inc., Wilmington, MA (US)

(21) Appl. No.: 19/437,902

(22) Filed: Dec. 31, 2025

Related U.S. Application Data
(60) Provisional application No. 63/744,148, filed on Jan. 10, 2025.

(51) Int. Cl. G06T 7/00; G06T 3/4046; G06V 10/25; G06V 10/774; G06V 10/82; G06V 10/94

(52) U.S. Cl. CPC G06T 7/0004; G06T 3/4046; G06V 10/25; G06V 10/774; G06V 10/82; G06V 10/95; G06T 2207/20081; G06T 2207/20084; G06T 2207/30148

(57) ABSTRACT

The present application provides a method and system of processing an image of a semiconductor substrate to identify defects in the semiconductor substrate. This disclosure relates to improving defect detection in increasingly complicated circumstances. For example, as circuitry on chips gets more complicated and features continue to shrink, it gets more complicated to determine defects. Defects can be any irregularity, issue, or mistake with a circuit on a substrate. A way to improve defect detection is to select regions of interest (ROI) and apply different recognition techniques to the different regions of interest. The different recognition techniques can involve different artificial intelligence (AI) models.

### CROSS-REFERENCE TO RELATED APPLICATIONS

This application claims the benefit under 35 U.S.C. § 119(e) of U.S. Provisional Patent Application Ser. No. 63/744,148, filed Jan. 10, 2025 under Attorney Docket No. O0474.70004US00 and entitled “METHOD AND SYSTEM FOR INSPECTION OF DEFECTS IN SEMIDOCONDUCTOR FABRICATION,” which is hereby incorporated by reference herein in its entirety.

### TECHNICAL FIELD

The present disclosure is directed to a method and system of processing an image of a semiconductor substrate to identify defects. More particularly, the method and system uses image processing techniques, and the utilization of machine learning algorithms for analyzing and manipulating images and thereby identifying defects on a substrate.

### BACKGROUND

The semiconductor fabrication process requires precise and accurate inspection methods to ensure the quality, yield and functionality of the produced components. Optical inspection systems are vital in the semiconductor manufacturing industry, where precision and reliability are paramount. These systems are used to detect defects on semiconductor wafers, which can range from physical imperfections to subtle variations in pattern consistency. As the complexity of semiconductor devices increases, the challenge of maintaining high-quality inspection standards becomes more significant, especially as the scale of defects becomes smaller and the patterns on wafers more intricate. In conventional state of art pre-defined algorithms and simple image processing techniques have been used, that often lack in differentiating between actual defects and acceptable variations in increasingly complex wafer backgrounds. Variability in the patterns, noise, and unpredictable factors make it difficult for conventional systems and methods, to consistently and accurately identify defects. Such limitations can lead to both false positives, which result in unnecessary production delays, and false negatives, which compromise the quality of the final product.

### SUMMARY

This disclosure relates to improving defect detection in increasingly complicated circumstances. For example, as circuitry on chips gets more complicated and features continue to shrink, it gets more complicated to determine defects. Defects can be any irregularity, issue, or mistake with a circuit on a substrate. A way to improve defect detection is to select regions of interest (ROI) and apply different recognition techniques to the different regions of interest. The different recognition techniques can involve different artificial intelligence (AI) models.

One aspect of the present disclosure provides a method of processing an image of a semiconductor substrate to identify defects in the semiconductor substrate. The method comprising of, receiving an image of the semiconductor substrate; identifying a first region of interest (ROI) and a second ROI of the image of the semiconductor substrate; generating a first object recognition result for defects in the first ROI by applying a first instance of a machine learning model to the first ROI, the first instance of the machine learning model being trained to identify defects against a background of the image in the first ROI; generating a second object recognition result for defects in the second ROI by applying a second instance of the machine learning model to the second ROI, the second instance of the machine learning model being trained to identify defects against a background of the image in the second ROI; and merging the first object recognition result and the second object recognition result.

Another aspect of the present technology provides a computer readable storage medium storing processor-executable instructions configured to, when executed by at least one processor, cause performance of a method of processing an image of a semiconductor substrate to identify defects in the semiconductor substrate, the method comprising: receiving the image of the semiconductor substrate; identifying a first region of interest (ROI) and a second ROI of the image of the semiconductor substrate; generating a first object recognition result for defects in the first ROI by applying a first instance of a machine learning model to the first ROI, the first instance of the machine learning model being trained to identify defects against a background of the image in the first ROI; generating a second object recognition result for defects in the second ROI by applying a second instance of the machine learning model to the second ROI, the second instance of the machine learning model being trained to identify defects against a background of the image in the second ROI; and merging the first object recognition result and the second object recognition result.

Another aspect of the present technology provides an apparatus for automated inspection of a semiconductor substrate. The apparatus comprising a stage for holding the semiconductor substrate; an imaging camera configured to capture an image of the semiconductor substrate; and processing circuitry configured to: receive the image of the semiconductor substrate; identify a first region of interest (ROI) and a second ROI of the image of the semiconductor substrate; generate a first object recognition result for defects in the first ROI by applying a first instance of a machine learning model to the first ROI, the first instance of the machine learning model being trained to identify defects against a background of the image in the first ROI; generate a second object recognition result for defects in the second ROI by applying a second instance of the machine learning model to the second ROI, the second instance of the machine learning model being trained to identify defects against a background of the image in the second ROI; and merge the first object recognition result and the second object recognition result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is an image depicting different types of defects that occurs on the semiconductor substrate, in accordance with an embodiment of the disclosure.

FIG. 2 is an image depicting a Convolutional neural network (CNN) model, in accordance with an embodiment of the disclosure.

FIG. 3 depicts a method of processing an image of a semiconductor substrate to identify defects in the semiconductor substrate, in accordance with an embodiment of the disclosure.

FIG. 4 schematically depicts a remote AI server integrated with the inspection, in accordance with an embodiment of the disclosure.

FIG. 5 schematically depicts defect identification of first and second regions of interest, in accordance with an embodiment of the disclosure.

FIG. 6 schematically depicts defect identification of multiple regions of interest, in accordance with an embodiment of the disclosure.

FIG. 7 schematically depicts a Convolutional neural network (CNN) model configured to identify defects in a semiconductor substrate, in accordance with an embodiment of the disclosure.

FIG. 8 schematically depicts a neuron of the Convolutional neural network of FIG. 7.

FIG. 9 schematically depicts an apparatus for automated inspection of a semiconductor substrate, in accordance with an embodiment of the disclosure.

FIG. 10 schematically depicts an example computer subsystem configured to identify defects on a semiconductor substrate, in accordance with an embodiment of the disclosure.

### DETAILED DESCRIPTION

Detection of defects on substrates is important to ensuring that mircofabricated devices work as intended. As the complexity of semiconductor devices increases, the challenge of maintaining high-quality inspection standards becomes more significant, especially as the scale of defects becomes smaller and the patterns on wafers more intricate. Conventional state of art pre-defined algorithms and simple image processing techniques often lack in differentiating between actual defects and acceptable variations in increasingly complex wafer backgrounds. Variability in the patterns, noise, and unpredictable factors make it difficult for conventional systems and methods, to consistently and accurately identify defects. Such limitations can lead to both false positives, which result in unnecessary production delays, and false negatives, which compromise the quality of the final product.

In general terms, the present disclosure relates to improvements in semiconductor panel or wafer lithography, and more specifically, addressing the problem of improving object recognition within optical inspection systems. The present disclosure utilizes advanced recognition algorithms capable of adapting to complex and diverse background patterns, allowing for enhanced defect detection accuracy in semiconductor substrates.

Inspection can be any kind of metrology-related operations as well as operations related to detection and/or classification of defects in a semiconductor substrate during its fabrication. Inspection can be carried out by using non-destructive inspection tools during or after manufacture of the semiconductor substrate to be inspected. By way of non-limiting example, the inspection process can include runtime scanning (in a single or in multiple scans), sampling, reviewing, measuring, classifying and/or other operations provided with regard to the semiconductor substrate or parts thereof using the same or different inspection tools. Likewise, at least partial inspection can be carried out prior to manufacture of the semiconductor substrate to be examined, and can include, for example, generating an inspection recipe(s), training respective classifiers or other machine learning-related tools and/or other setup operations. It is noted that, unless specifically stated otherwise, the term “inspection” or its derivatives used in this specification, is not limited with respect to resolution or to the size of an inspection area. A variety of non-destructive inspection tools includes, by way of non-limiting example, scanning electron microscopes, atomic force microscopes, optical inspection tools, etc.

A semiconductor wafer is generally a flat discoid object of varying diameter. Semiconductor wafers are generally formed of a semiconductor material such as silicon, gallium arsenide, and the like, though in some instances Glassell composite materials such as epoxy can be used. In some embodiments, the semiconductor wafer can include an orientation structure such as a notch, mark, flat or other structure. Such semiconductor wafers frequently have a diameter of between about 200 mm and about 300 mm, but other sizes of semiconductor wafers are also common.

A semiconductor panel is generally a flat object made of semiconductor materials, glass, or composite materials. Semiconductor panels typically have a rectangular or square shape and come in a variety of sizes, although there are common sizes referred to as “generations” with specific dimensions follow: Gen. 1:300×400 mm; Gen. 2:360×465 mm; Gen. 2.5:400×500 mm; Gen. 3:550×650 mm; Gen. 3.5:620×750 mm; Gen. 4:730×920 mm; Gen. 5:1100×1300 mm; Gen. 6:1500×1850 mm; Gen. 7:1870×2200 mm; Gen. 7.5: 1950×2200 mm; and Gen. 8:2200×2500 mm. Advanced integrated circuit substrates (AICS) may have the following dimensions: 510×515 mm; or 600×600 mm. In some embodiments, the semiconductor panel can be in the form of a copper core laminate (CCL) panel, etc. In some embodiments, the semiconductor panel can be a glass panel substrate, or other panel constructed of soda-lime glass treated with one or more special coatings to improve the adhesion and uniformity of deposited materials.

A semiconductor substrate is a substrate that includes semiconductor material, glass, copper clad laminate, or any other material. A semiconductor substrate can be a semiconductor panel or a semiconductor wafer. Where some specific information specific to either a wafer or a panel, respectively, is to be related, the specific terms will be used. In some embodiments, either a wafer or a panel can serve as a base upon one or more layers of material are applied and processed to create a multilayered semiconductor substrate. For example, the one or more layers can include one or more redistribution layers, which may include conductive traces, interspaced between insulative, dielectric layers. Through holes can be defined in the wafer or a panel to enable communication between layers applied to opposing major surfaces of the wafer or a panel.

In some embodiments, the semiconductor substrate can include an array of repeated functional units, each of which can represent a portion of a semiconducting substrate on which a given functional circuit is fabricated. For example, in one non-limiting example, the functional circuit can take the form of a central processing unit. In some embodiments, additional electrical components can be electrically coupled to the semiconductor panel to complete the functional unit. In other embodiments, the layered semiconductor panel itself can represent a completed functional unit.

Each of the functional units can then be cut from the semiconductor panel into (e.g., rectangular shaped) dies, wherein each die contains one copy of the functional circuit. To avoid damage to the dies, in some embodiments, a thin, non-functional spacing can be provided between dies, allowing for cutting (e.g., with a saw) of individual dies from a substrate without damaging the circuits. In this manner, a functional circuit can be batch manufactured on a single semiconductor substrate. Once cut into individual dies, the dies can be applied to a printed circuit board for use in electronics.

As the fabrication process progresses, defects can occur in different regions of the semiconductor substrate. These defects may arise from real and physical phenomena of the substrate, and false events/nuisance defects i.e. the nuisance can be an irregularity or false defect on the substrate. The number of defects across the entire semiconductor substrate may increase as more layers are added, leading to cumulative errors.

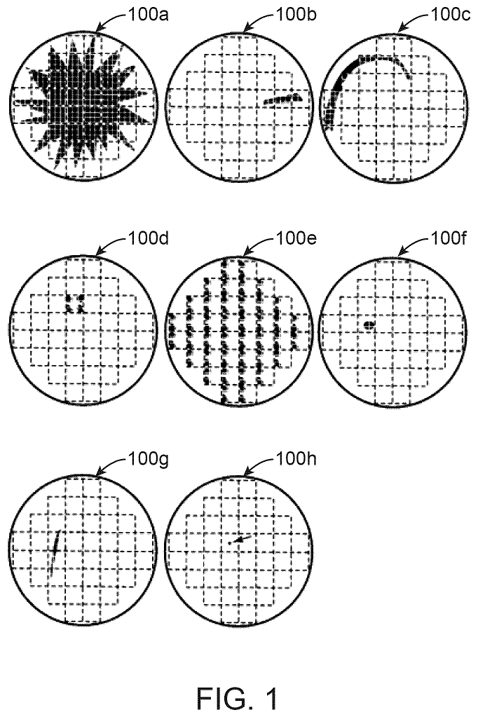

As used herein, defects generally include one or more of a surface defect, an epitaxial stacking defect, a scratch defect, a particulate residual defect, a slide line defect, RDL line bridging, dielectric breakdown, corrosion or any foreign material substances such as dust or polishing material or slurry adhered to the substrate surface, crystal-originated defects such as crystal-originated particles or pits. Automated inspection systems identify these defects from semiconductor substrate images and classify them based on the type of defect identified. FIG. 1 shows different types of defects that may occur on the semiconductor substrate. Defect 100a shows coating unevenness defects caused by coating drop scatter, defect 100b shows a defect arising when foreign matter adheres to the substrate and defect 100c shows spiral unevenness on substrate due to viscosity of the coating material. Further, defect 100d, defect 100e, defect 100f, defect 100g, and defect 100h depict defects like differing surface states due to exposure shift or machine tilt, and presence of foreign material such as dust or scratches.

Region of interest (ROI) refers to a specifically defined area within a target image of the semiconductor substrate that is inspected for defect detection. The target image of the semiconductor substrate may be divided into multiple regions of interest, wherein each ROI is analyzed separately using the defect detection method. Selecting an ROI for separate defect detection, facilitates targeted analysis using advanced image processing techniques and machine learning algorithms, resulting in enhanced defect identification and improved yield in semiconductor manufacturing process.

Artificial Intelligence (AI) such as a machine learning models are used to reduce semiconductor manufacturing losses due to defective substrates. Machine learning based monitoring and inspection aids in early defect detection leading to improved quality and yield. Although machine learning defect detection models may exist and be used, effective defect detection depends on the techniques of applying these models during the inspection process. Existing labeled training defect data can be highly unbalanced, which may have a negative impact on the training of machine learning (ML) classifiers, such as deep learning (DL) classifiers, as a non-limiting example. In addition, many images of semiconductors that are actually defective may not be classified as such by a trained ML classifier due to inherent insufficiencies of image preprocessing techniques. Traditional image processing techniques struggle with distinguishing weak defect and objects of strong background on the substrate, which results in the need manual intervention for operationally effective defect detection.

Methods and/or apparatus described herein are used to generate high-quality defect data from a target image. Training data sets having imbalances in modeling and/or analysis may be improved. Some of the methods may be used for reliable large-scale defect detection performed on semiconductor substrate images having strong background. Some of the methods may be used to perform image selection, find a region of interest (ROI), process various inputs, and apply a model for each selected region of interest (ROI) for defect detection.

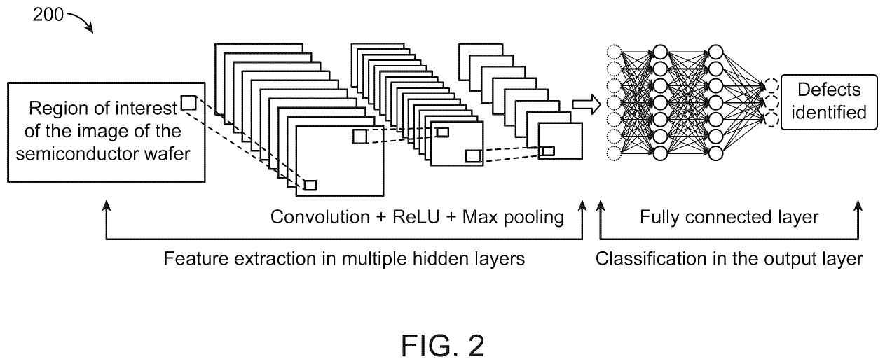

As used herein, Convolutional neural network (CNN) models is a type of machine learning model used for defect identification on a semiconductor substrate. Referring to FIG. 2, a selected region of interest (ROI) of an image of the semiconductor substrate is input into the CNN model where it is processed for defect identification. The process involves, feeding high-resolution images of the substrates into the CNN, where the pixel data of the image is processed by convolutional layers. The convolutional layers perform convolution operations on the input data for feature extraction and generate feature maps based on the extracted features of the target image. A Rectified Linear Unit (ReLU) activation function is applied on the generated feature, maps for introducing non-linearity into the model. Subsequently, max pooling layers are applied to down sample the feature maps for reducing the computational complexity of the model. At this stage, the model ignores the less important features and retains only the significant features present in feature map.

Further referring to FIG. 2, following the convolution and pooling operations, the feature maps are flattened into a one-dimensional vector and fed into fully connected layers. The fully connected layers includes multiple layers where each neuron one layer is connected to every neuron in the previous layer for synthesizing the extracted features for defect classification, which is subsequently analyzed by an output layer. The output layer uses logistic functions, such as sigmoid or softmax, for converting raw scores from the previous layer into probability distributions that indicate the most likely defect present on the semiconductor substrate. The goal of the convolutional neural network is to solve problems in the same way that the human brain would, through the use of specific networked pathways which may resemble networks in the human brain. As per present disclosure, a separate instance of the CNN model is applied on each input ROI for achieving improved defect detection and streamlined manufacturing processes.

Embodiments described herein may relate to methods of identifying a defective semiconductor substrate by detecting or identifying a defect in a corresponding semiconductor substrate image. Multiple and adaptive or dynamic operation modes may be used to provide an apparatus for identifying defective semiconductors or semiconductor substrates. Embodiments of the apparatus, and methods thereof, may be widely applicable to all types of substrates, processing, and equipment.

According to one aspect of the present disclosure, a method of processing an image of a semiconductor substrate to identify defects in the semiconductor substrate is disclosed. The method comprises receiving an image of a semiconductor substrate and identifying a first region of interest (ROI) and a second ROI of the image of the semiconductor substrate. The method as per the present disclosure further comprises, generating a first object recognition result for defects in the first ROI by applying a first instance of a machine learning model to the first ROI, the first instance of the machine learning model being trained to identify defects against a background of the image in the first ROI and generating a second object recognition result for defects in the second ROI by applying a second instance of the machine learning model to the second ROI, the second instance of the machine learning model being trained to identify defects against a background of the image in the second ROI. The object recognition results may be a list of defect locations and types. Thus, separate lists may be generated for the separate ROIs in some embodiments. The method further comprises, merging the first object recognition result and the second object recognition result for generating a compiled list of defects (including defect type and location) identified on the semiconductor substrate. The method provides the advantage of optimization by using machine learning models to identify defects in different regions of interest (ROI) in the semiconductor substrate image, enabling efficient and accurate defect detection.

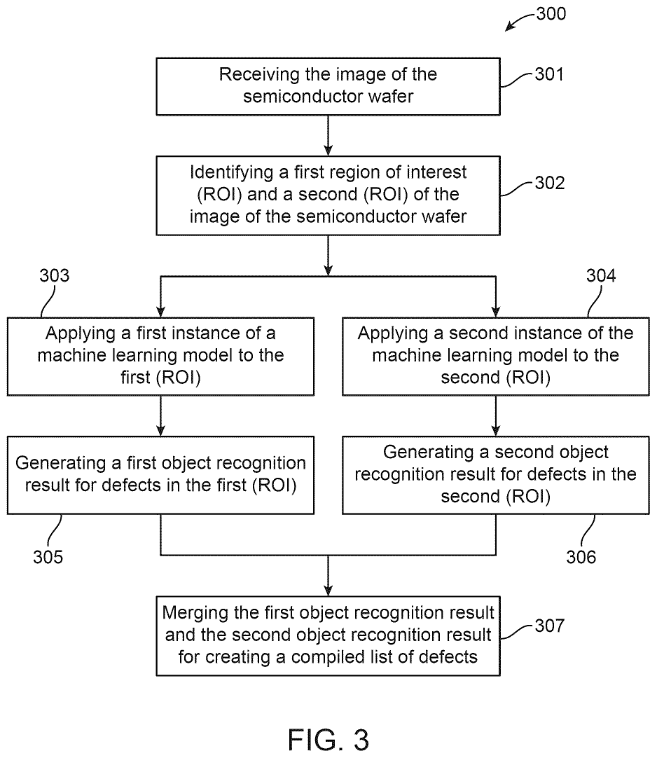

Referring to FIG. 3, the method of processing an image of a semiconductor substrate to identify defects in the semiconductor substrate is disclosed. The method comprises step 301, receiving an image of the semiconductor substrate to be inspected by the inspection tool, wherein the image of the semiconductor substrate is a target image. As present disclosure, the target image is generated by scaling a raw image of the semiconductor substrate of varying shapes, preferably from a rectangular shape to a square shape. The raw image of the semiconductor substrate, may be a high definition image captured by an imaging system present on the inspection tool having a pixel size less than 6 microns, less than 1 micron, less than 0.5 microns, and down to 0.02 microns. In some embodiments, the image of the semiconductor substrate received by the inspection tool may be an Electron microscope image, an X-ray image, an optical or a thermal image, which provide a raw image of the semiconductor substrate for defect identification.

The method 300 as depicted in FIG. 3, further comprises step 302, identifying a first region of interest (ROI) and a second ROI of the image of the semiconductor substrate. ROIs may be defined by areas having common shapes or patterns in some embodiments. In some embodiments, a user may manually define the ROIs, for example by drawing a box around different ROIs. In some embodiments, ROIs may be determined automatically, for example by applying a machine learning model to the image of the semiconductor wafer, where the machine learning model is a different machine learning model than may be applied in later stages of the method 300. In some embodiments, identifying an ROI of the image of the semiconductor substrate may involve, performing initial image analysis to highlight areas that deviate from expected patterns, focusing on anomalies or irregularities indicative of defects. This step employs techniques such as edge detection for delineating boundaries of features within the image. The process of edge detection is followed by thresholding for image segmentation based on pixel intensity to distinguish potential defects from the background. Once the ROIs are determined based on these criteria, they are isolated for individual preprocessing steps such as noise reduction, contrast enhancement, and normalization, ensuring effectively analysis of each the identified ROI for defect detection.

As per present disclosure, a first and second ROI is identified for an image of the semiconductor substrate to be inspected. In some embodiments, the first ROI and the second ROI identified on the semiconductor substrate do not overlap. In alternative embodiments, the first ROI and the second ROI identified on the semiconductor substrate may overlap. In a non-limiting embodiment, the method of processing an image of a semiconductor substrate to identify defects may comprise of identifying multiple regions of interest of the image of the semiconductor substrate, which may or may not overlap with each other.

The identified regions of interest (ROI), in some embodiments are separately preprocessed prior to defect identification. The identified ROI of the image of the semiconductor substrate may be filtered by one or more filters in real space and/or Hilbert space, including linear and non-linear filters. In some embodiments identified ROI of the image may be filtered by a first filter to generate a first set of intermediate images, for example, a darkfield image and a brightfield image. The first filter may be provided as one or more linear filters in different bandwidths, e.g., high, low, bandpass filters. The first set of intermediate images may then be combined and filtered by a second filter to generate a second intermediate image. The second filter may be provided as one or more linear filters. The second intermediate image may be filtered by a third filter to generate a preprocessed image of the identified ROI. The third filter may be provided as one or more non-linear filters. As depicted in FIG. 5, the first ROI 501 and second ROI 502 identified in the image of the semiconductor substrate are preprocessed 503 and inspected for defects. The first ROI 501 and second ROI 502 are separately preprocessed 503 to make the contrast in the image more pronounced, thus aiding in detecting low-contrast defects in the identified ROI. After the preprocessing, inference with a model can be performed. For the first ROI 501, inference with a first model can be performed in step 504 and inference with a second model can be performed in step 505. The outputs of steps 504 and 505 can be combined in step 506 and the defects can be reported.

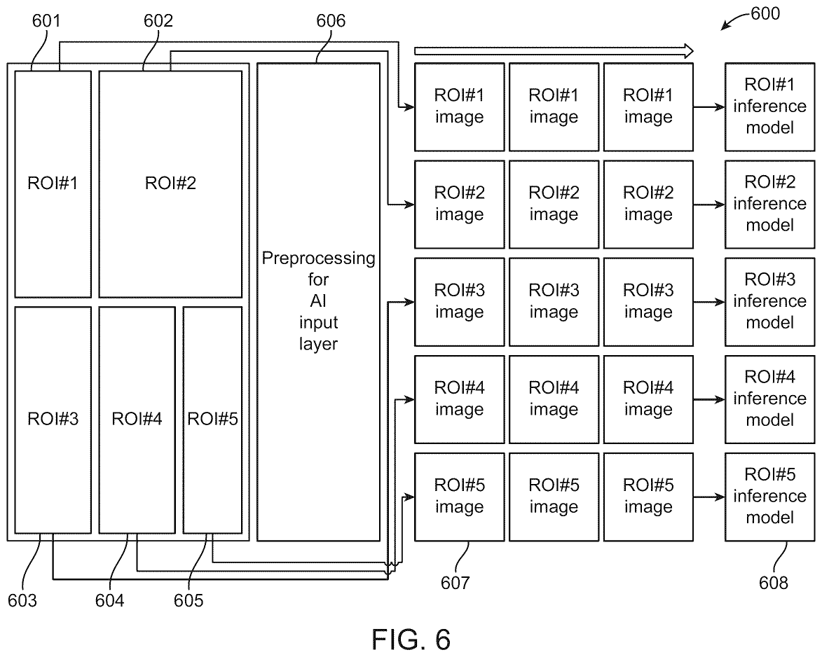

The method of processing an image of a semiconductor substrate to identify defects further comprises step 303, applying a first instance of a machine learning model to the first ROI for generating a first object recognition result for defects in step 305. The object recognition result may be a list of defect locations and types. The method further comprises step 304, applying a second instance of the machine learning model to the second ROI for generating a second object recognition result for defects in step 306. The object recognition result may be a list of defect locations and types. Furthermore, as per the present disclosure, the first and second instances of the machine learning model are trained to identify defects against a background of the image in the respective regions of interest. The first instance of the machine learning model is trained to identify defects against a background of the image in the first ROI and the second instance of the machine learning model is trained to identify defects against a background of the image in the second ROI. In some embodiments, the method comprises identifying multiple regions of interest and applying separate instances of machine learning models on each of the identified regions of interest as shown in FIG. 6. In FIG. 6, five different regions of interest (ROI) can be identified. These ROI include ROI #1 601, ROI #2 602, ROI #3 603, ROI #4 604, and ROI #5 605. As shown, these ROI can be spread over the image of the substrate and comprise different areas, backgrounds, and defects. Next the images from the different ROIs can be preprocessed 606 for the AI input layer. That is, one or more images 607 may be generated for each of the ROIs. If there is a single instance of a given ROI on a substrate being inspected, then a single ROI image may be generated. If there are multiple instances of the ROI on a substrate, such as when there are multiple die on a wafer and each die has the ROI of interest (e.g., ROI #1 601), then multiple images 607 corresponding to that ROI may be generated. In the example of FIG. 6, the illustrated pipeline processing shows that three image 607 are generated for each ROI, but other numbers of images may be generated. The generated images 607 are then processed by a corresponding ROI inference model 608. That is, the images 607 corresponding to ROI #1 601 are input to and processed by ROI #1 inference model. Likewise, the images 607 corresponding to ROI #2 602 are input to and processed by ROI #2 inference model, and so on for all the ROIs. The utilization of distinct instances of a machine learning model tailored to specific regions of interest enhances the accuracy of defect detection by adapting to variations in the background of different substrate areas. In alternative embodiments, instead of applying distinct instances of the same machine learning model in steps 303 and 304, those two steps may employ different machine learning models having different structures.

The machine learning model used in the method of processing an image of a semiconductor substrate to identify defects is a trained Convolutional neural network (CNN) model. The first instance of the machine learning model is a trained CNN based first inference model and the second instance of the machine learning model is a trained CNN based second inference model. Further referring to FIG. 5, each of the identified regions of interest preprocessed individually and given as input to the respective CNN model for defect detection against a background of the image in the respective regions of interest. As per present disclosure, the first ROI is preprocessed and given as input to the first inference model, where a first instance of the CNN model is applied on the first ROI for defect detection. Furthermore, the preprocessed images the second ROI is provided as input into the second inference models\ for defect detection, where a second instance of the CNN model is applied on the second ROI for defect detection. In some embodiments, the method comprises, applying multiple instances of the CNN model, to respective the multiple ROIs, for defect detection against a background of the image in the identified regions of interest. The method offers the advantage of automation by utilizing a convolutional neural network as the machine learning model enabling it to automatically recognize defects against the background of the image without manual intervention.

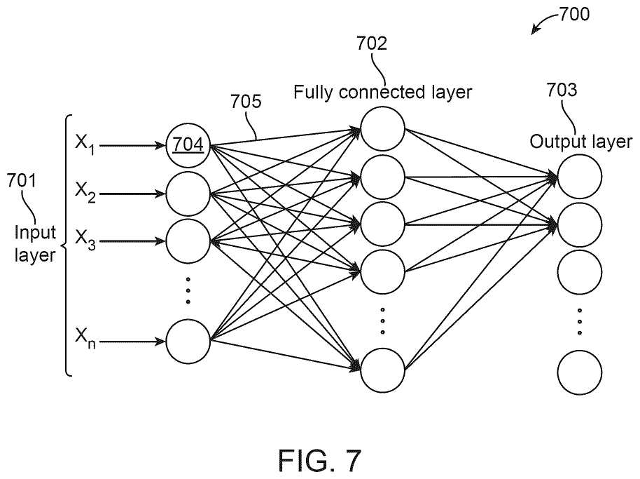

The inference model performs the defect detection of an identified ROI based on a trained CNN model. Referring to FIG. 7, the preprocessed image of the identified ROI is input into the Convolutional neural network 700, to identify of the presence or absence of a defect on the manufactured semiconductor substrate. Convolutional neural networks typically consist of multiple layers, and the signal path traverses from front to back. The multiple layers perform a number of algorithms or transformations. The number of layers in some embodiments may not be significant and is use case dependent. As per the present disclosure, a suitable range of layers is from two layers to a few tens of layers. Modern convolutional neural network projects typically work with a few thousand to a few million neural units and millions of connections.

The Convolutional neural networks, in an example scenario, may have two sets of neurons: one that receive an input signal and one that send an output signal. When the input layer receives an input, it passes on a modified version of the input to the next layer. In a based model, there are many layers between the input and output, allowing the algorithm to use multiple processing layers, composed of multiple linear and non-linear transformations. An observation (e.g., an image) can be represented in many ways such as a vector of intensity values per pixel, or in a more abstract way as a set of edges, regions of particular shape, etc.

With additional reference to FIG. 7, as per the present disclosure, it is depicted that the Convolutional neural network 700 can include an input layer 701, one or more fully connected layer (hidden layers) 702, and output layer 703. Each of the layers 701, 702, 703 can include a corresponding plurality of neurons 704. Although only a single hidden layer 702 is depicted, in some embodiments the Convolutional neural network 700 may include as few as one hidden layer or as many hidden layers as desired.

The inputs for the input layer 701 may be any number along a continuous range (e.g., any number between 0 and 255, etc.) which represents the pixel data of the preprocessed target image. In some embodiments, the number of neurons present in the input layer 701 is based on pixel data of the target image, wherein each of the input values represents one pixel (e.g., based on a grayscale or RGB color code). In another embodiment, the input layer 701 can include three layers of inputs for each pixel, wherein each of the input values is based on a numerical color code for each of the R, G, and B colors; other quantities of neurons and input values are also contemplated.

In some embodiments, each of the neurons 704 in a given layer (e.g., input layer 701) can be connected to each of the neurons 704 of the subsequent layer (e.g., hidden layer 702) via a connection 705, as such, the layers of the network can be said to be fully connected. In another embodiment, the algorithm is a convolutional neural network, wherein a distinct group of input layer 701 neurons (e.g., representing a local receptive field of input pixels) can couple to a single neuron in a hidden layer 702 via a shared weighted value. In some embodiments the distinct group of input layer neurons can be selected based on a pixel intensity or other numerical value representing qualities of the pixel.

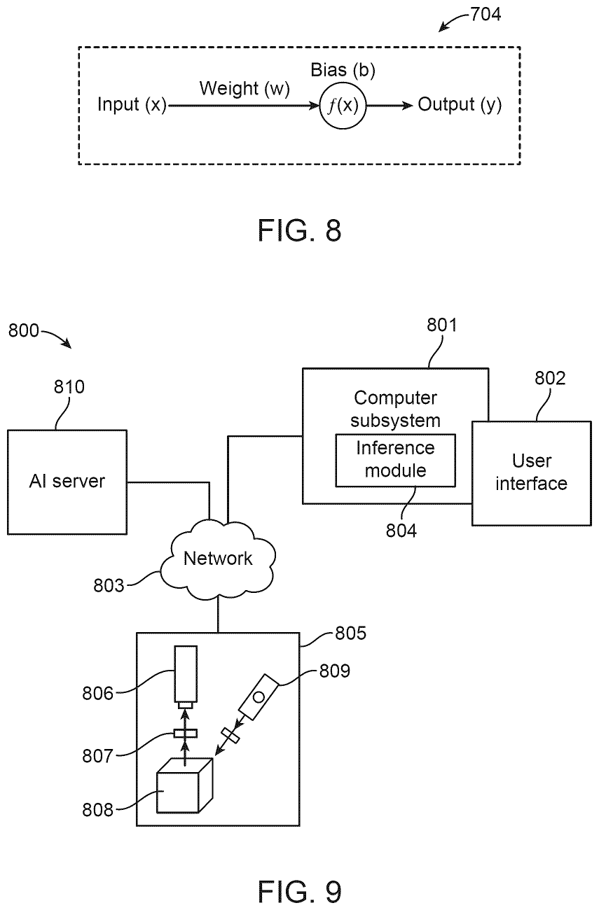

With additional reference to FIG. 8, it is illustrated that each of the neurons 704 can be configured to receive one or more input values (x) and compute an output value (y). In fully connected networks, each of the neurons 704 can be assigned a bias value (b), and each of the connections 705 can be assigned a weight value (w). Collectively the weights and biases can be tuned as the Convolutional neural network 700 learns how to correctly classify detected objects. Each of the neurons 704 can be configured as a mathematical function, such that an output of each neuron 704 is a function of the connection weights of the collective input, and the bias of the neuron 704, according to the following relationship: y≡w·x+b.

In some embodiments, output (y) of the neuron 704 can be configured to take on any numerical value (e.g., a value of between 0 and 1, etc.). Further, in some embodiments the output of the neuron 704 can be computed according to one of a linear function, sigmoid function, tanh function, rectified linear unit, or other function configured to generally inhibit saturation (e.g., avoid extreme output values which tend to create instability in the Convolutional neural network 700).

In some embodiments, the output layer 703 can include neurons 704 corresponding to a desired number of outputs of the convolutional neural network 700. In one embodiment, the convolutional neural network 700 may include a plurality of output neurons sub-dividing ROI of the semiconductor substrate into a number of distinct regions in which the likelihood of the presence of a defect can be indicated with an output value. Other quantities of output neurons are also inspected, for example, the output neurons could correspond to object classifications (e.g., comparison to a database of historical images), in which each output neuron would represent a degree of likeness of the present image to one or more historical images of a known defect.

The Convolutional neural network 700 is trained by tuning the weights and balances of until the inputs to the input layer 701 are properly mapped to the desired outputs of the output layer 703, thereby enabling the algorithm to accurately produce outputs (y) for previously unknown inputs (x). In some embodiments, the convolutional neural network 700 can rely on training data (e.g., inputs with known outputs) to properly tune the weights and balances.

In training the Convolutional neural network 700, a cost function (e.g., a quadratic cost function, cross entropy cross function, etc.) is used to establish how close the actual output data of the output layer 703 corresponds to the known outputs of the training data. Each time the Convolutional neural network 700 runs through a full training data set can be referred to as one epoch. Progressively, over the course of several epochs, the weights and balances of the Convolutional neural network 700 can be tuned to iteratively minimize the cost function.

Effective training of the Convolutional neural network 700 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the Convolutional neural network 700. As a result, the backpropagation algorithm serves as a way of keeping track of small perturbations to the weights and biases as they propagate through the network, reach the output, and affect the cost. In some embodiments, changes to the weights and balances can be limited to a learning rate to prevent overfitting of the Convolutional neural network 700 (e.g., making changes to the respective weights and biases so large that the cost function overshoots the global minimum). For example, in some embodiments, the learning rate can be set between, about 0.03 and about 10. Additionally, in some embodiments, various methods of regularization, such as L1 and L2 regularization, can be employed as an aid in minimizing the cost function.

In one embodiment, the first instance of the CNN 700 is trained to identify defects against a background of the image in the first ROI. Referring to FIG. 5, the preprocessed image of first ROI is input into the first inference model, where the first instance of CNN 700 generates a first object recognition result for defects identified in the first ROI (ROI #1).

In another embodiment, the second instance of the CNN 700 is trained to identify defects against a background of the image in the second ROI. Referring to FIG. 5, the preprocessed image of second ROI is input into the second inference model, where the second instance of CNN 700 generates a second object recognition result for defects identified in the second ROI (ROI #2).

Referring again to FIG. 3, the method of processing an image of a semiconductor substrate to identify defects in the semiconductor substrate further comprises step 307, merging the first object recognition result and the second object recognition result. As per present disclosure, the first object recognition result is output from the first inference model (ROI #1 inference model) and the second object recognition result is output from the second inference model (ROI #2 inference model). The merging the first object recognition result and the second object recognition result comprises creating a compiled list of defects from the first object recognition result and the second object recognition result. In some embodiments, the method identifies multiple regions of interest and applies a distinct instance of the machine learning model to each of the regions of interest to generate an object recognition result for each of the ROIs. Furthermore, the object recognition results from each of these instances of the machine learning model (e.g., the lists of defect types and locations) are merged to generate a compiled list of defects, including defect types and locations. This aids in achieving an optimized list of defects for each semiconductor substrate and streamline the manufacturing process by further training the inference module using the compiled list of defects. In some embodiments, merging defect lists for separate ROIs into a single list may also involve applying logic, such as but not limited to prioritizing certain types and/or locations of defects, deduplication (removing) of entries (e.g., when the ROIs overlap), or removal of low priority defects. Such logic may be user-defined.

In some embodiments, training of a machine learning model, is performed based on a set training images of the type of semiconductor substrate to be inspected by the inspection tool. The training images may undergo preprocessing to enhance the contrast of the image and other type of transformations to enhance one or more particular features of the image. Binary slices may be taken of the image, each binary slice corresponding to a different range of grayscale levels. Each binary slice may then be segmented using statistical properties, where each segment is defined by a contrast profile for that region of the image. The segment(s) with a known defect are labeled accordingly and segments with no or known defects are also labeled accordingly. The segments are fed into the machine learning model, and the output is set based on the labels (e.g., type of defect or no defect). The machine learning model trains itself to detect the defects based on the segments and the defect labels of the segments.

As per present disclosure, the first and second instances of the machine learning model are separately trained to identify defects specifically present in first and second regions of interest. Each of the instances of the machine learning model are specifically trained using a set of ROI images to identify defects specific to that particular region of interest. The first instance of the machine learning model is trained using first set of training images same as the first ROI to identify unique defects against a background of the image in the first ROI. Similarly, the second instance of the machine learning model is trained using a second set of training images same as the second ROI, to identify unique defects against a background of the image in the second ROI. In some embodiments, the method identifies multiple regions of interest and applies a distinct instance machine learning model to each of these regions of interest. Each of the distinct instances of the machine learning model are individually trained to identify defects specific to its corresponding region of interest. The method of processing an image of a semiconductor substrate to identify defects in the semiconductor substrate as depicted in FIG. 3, comprises step 302 of identifying a first ROI and a step 303 of applying a first instance of a machine learning model to the first ROI, wherein the first instance of the machine learning model being trained to identify defects against a background of the image in the first ROI. When an input image of the first ROI is received into the first inference model, the first instance of the machine learning model identifies the defects and labels them, based on the first set of training images. The method further comprises step 302 of identifying a second ROI and a step 304 of applying a second instance of a machine learning model to the second ROI, wherein the second instance of the machine learning model being trained to identify defects against a background of the image in the second ROI. When an input image of the second ROI is received into the second inference model, the second instance of the machine learning model identifies the defects and labels them, based on the second set of training images.

As per present disclosure, the machine learning model is communicatively coupled to remote server configured re-train the instances of the machine learning model using the defects identified in the respective regions of interest. The first object recognition result from the first region of interest is send to the AI server that is configured to re-train the first instance of the machine learning model based on the identified defects. The remote AI server adjusts its training parameters to match the current input obtained from the first object recognition result and re-trains the first instance of the machine learning model for optimized defect identification. Furthermore, the second object recognition result from the second region of interest is sent to the AI server that is configured to re-train the second instance of the machine learning model based on the identified defects. The remote AI server further adjusts its training parameters to match the second object recognition result and re-train the second instance of the machine learning model to accurately identify defects against a background of the image in the second ROI. The AI server facilitates continuous improvement of the object recognition models through iterative training processes, ensuring adaptability to evolving inspection requirements.

In some embodiments, the method of processing an image of a semiconductor substrate allows for the identification and extraction of multiple Regions of Interest (ROIs) within an image of a semiconductor substrate as shown in FIG. 6, wherein a separate CNN model is applied each of these identified ROI using the corresponding inference model for defect identification in the specific ROIs. The method further handles and consolidates object recognition results from all the multiple ROIs to ensure a coherent and comprehensive understanding of the inspected semiconductor substrate. As per present disclosure, the method of processing an image of a semiconductor substrate to identify defects in the semiconductor substrate functions in real-time which aids in reducing runtime errors and increasing production yield. The continuous re-training of the machine learning models helps in achieving improved accuracy over time. The method uses multiple CNN-based machine learning models, each specialized for specific types of defects. This flexibility enables the system to adapt to a variety of inspection scenarios.

According to another aspect of the present disclosure, an apparatus (or otherwise a system) for automated inspection of a semiconductor substrate is disclosed. The apparatus comprises of a stage for holding the semiconductor substrate and an imaging camera configured to capture an image of the semiconductor substrate. The apparatus further comprises a processing circuitry configured to receive the image of the semiconductor substrate and identify a first region of interest (ROI) and a second ROI of the image of the semiconductor substrate. In accordance with the present disclosure, the processing circuitry is further configured to generate a first object recognition result for defects in the first ROI by applying a first instance of a machine learning model to the first ROI and generate a second object recognition result for defects in the second ROI by applying a second instance of the machine learning model to the second ROI. As present disclosure, the first instance of the machine learning model being trained to identify defects against a background of the image in the first ROI and the second instance of the machine learning model being trained to identify defects against a background of the image in the second ROI. The processing circuitry is further configured to merge the first object recognition result and the second object recognition result. In some embodiments, the merging involves merging lists of defect types and locations to create a compiled list of defect types and locations. Moreover, in some embodiments, merging defect lists for separate ROIs into a single list may also involve applying logic, such as prioritizing certain types and/or locations of defects or removing duplicative entries (e.g., when the ROIs overlap). Such logic may be user-defined.

In some embodiments, the apparatus (or otherwise a system) for automated inspection of a semiconductor substrate comprises a processing circuitry that is configured to identify multiple regions of interest of the image of the semiconductor substrate. The process circuitry is configured to apply a distinct instance of the machine learning model to each of these identified ROIs, for generating multiple object recognition results, corresponding to each of the regions of interest. The process circuitry is further configured to merge the object recognition results from each instance of the machine learning model into a compiled list of defects. This approach, significantly reduces defects and improves overall yield, leading to more efficient production processes.

In a detailed embodiment of the present disclosure, FIG. 9 depicts an apparatus 800 for automated inspection of a semiconductor substrate 808. The semiconductor substrate 808 can be a completed semiconductor substrate, or a semiconductor substrate that has been only partially fabricated. The semiconductor substrate 808 can be, e.g., a semiconductor substrate of an integrated circuit. In some examples, the semiconductor substrate 808 can include an AICS. In one embodiment, the semiconductor substrate 808 can be fabricated according to an advanced packaging (AP) process flow. In some embodiments, the apparatus 800 can include one or more computer subsystems 801 interconnected to a network 803, and an inference module 804 configured to execute a convolutional neural network, as configured and described herein. In some embodiments, the inference module 804 may be a plugin inference module, that processes the image using a designated CNN-based model, ensuring real-time execution of these operations on inference module. The network 803, which can be wired or wireless, can serve to connect the one or more computer subsystems 801 with other system components including inspection tool 805 and a remote AI server 810. The computer subsystem 801 can include a user interface 802 for interacting with the computer subsystem.

The apparatus 800 for automated inspection of a semiconductor substrate comprises an inspection tool 805. The inspection tool 805 comprises a stage, an imaging camera 806 and a processing circuitry operating as computer subsystem 801. As per present disclosure the inspection tool 805 comprises a stage for holding the semiconductor substrate 808 to be inspected. The stage is preferably moving, and the movement of the stage may be accomplished by means for moving the stage. Such means for moving the stage may include, for example, one or more servo motors, stepper motor(s), or other means for moving the stage. Furthermore, the stage movement may be guided by system coordinates, thus moving the stage relative to optical elements of the apparatus 800 precisely.

The inspection tool 805 comprising an imaging camera 806 is configured to capture an image of the semiconductor substrate. In some embodiments the imaging camera 806 may include suitable optics and an imager such as a CCD or CMOS chip. In some embodiments, the imaging camera 806 can optionally include one or more lenses 807. For example, in some embodiments, the one or more lenses 807 can serve to magnify an image of the semiconductor substrate 808 (e.g., as part of a microscope). Additionally, in some embodiments the lenses 807 can represent one or more filters or polarizers, employed for nuisance suppression to reduce the presence of certain electromagnetic wavelengths generally associated with observable features on a specimen that do not represent defects on the semiconductor substrate 808.

The imaging camera 806 may be configured to capture different perspectives of the manufactured semiconductor substrate 808. In some embodiments, the imaging camera 806 may be configured to capture images represented by light across a broad range of the electromagnetic spectrum (e.g., visible light, ultraviolet light, x-ray, infrared light, monochromatic laser light, etc.).

As depicted in FIG. 9, the inspection tool 805 further includes a light source 809 configured to illuminate the manufactured semiconductor substrate 808. For example, the light source 809 is a single source, such as a broadband, white light emitting diode (LED) with optical fibers, mirrors, lenses, or filters to direct electromagnetic radiation from the light source 809 as desired, or multiple sources, with each source covering a different part of the electromagnetic spectrum. The light source 809 may include a visible light source such as a broadband LED (e.g., a white light LED) that has an emission spectrum that spans across a range of visible wavelengths. In other cases, the light source is an incandescent lightbulb, or other filament-based light source. In some embodiments, the light source 809 is of different illumination types (e.g., incandescent light, fluorescent light, monochromatic laser light, different spectrums of visible light, ultraviolet, x-ray, infrared, etc.).

The apparatus 800 for automated inspection of a semiconductor substrate further comprises a processing circuitry that operates as part of the computer subsystem 801. The processing circuitry is configured to receive the image of the semiconductor substrate from the imaging camera 806 to identify regions of interest (ROI), wherein the image of the semiconductor substrate has a pixel size less than 6 microns, less than 1 micron, down to less than 0.02 micron, or between 0.02 microns and 6 microns (e.g., 0.7 microns). The processing circuitry can be configured to scale the image of the semiconductor substrate from a rectangular shape to a square shape. The scaling of a raw image of the semiconductor substrate from a rectangular shape to a square shape standardizes the aspect ratio of the target images, which can simplify the processing and analysis algorithms used in subsequent defect identification steps. Converting the image to a square shape may facilitate improved performance of the image processing techniques and the functions of machine learning models, such as convolutional neural networks, which perform better with standardized input dimensions. Furthermore, the generation of a target image through scaling enhances the compatibility of the image data with a variety of display and analysis tools, which may be optimized for square images, thereby improving the efficiency of defect visualization and review processes.

The processing circuitry present in the computer subsystem 801 further identifies a first region of interest (ROI) and a second ROI of the image of the semiconductor substrate. The identification of an ROI of the image of the semiconductor substrate by the processing circuitry involves, performing an initial image analysis to emphasize areas that diverge from expected patterns, specifically targeting anomalies or irregularities that may indicate defects. Preprocessing leverages techniques like edge detection and thresholding techniques, which aids in image segmentation based on pixel intensity, allowing for the differentiation of potential defects from the background of the target image.

As per present disclosure, the processing circuitry identifies a first and second ROI for an image of the semiconductor substrate to be inspected. In some embodiments, the first ROI and the second ROI identified on the semiconductor substrate, do not overlap. In alternative embodiments, the first ROI and the second ROI identified on the semiconductor substrate may overlap. In some embodiments, the processing circuitry is configured to identify multiple regions of interest of the image of the semiconductor substrate, which may or may not overlap with each other.

The processing circuitry is further configured to apply distinct instances of a machine learning model on individual regions of interest, wherein each of these instances of the machine learning model are trained to identify defects in its corresponding region of interest. As per the present disclosure, a first instance of the machine learning model trained to identify defects unique to the first ROI and is applied to the first ROI to generate a first object recognition result for defects in the first ROI. Furthermore, the processing circuitry applies a second instance of the machine learning model trained to identify defects unique to the second ROI and generate a second object recognition result for defects in the second. In some embodiments, the process circuitry is configured to identify multiple regions of interest (ROIs), apply an individual instance of the machine learning model to each of the identified ROI, and generate separate object recognition results for each of the identified ROIs. The apparatus 800 has the advantage of performativity, by generating object recognition results for defects in each ROI separately. This allows for a more detailed analysis of defects in different areas of the semiconductor substrate.

The machine learning model used in the apparatus for automated inspection of a semiconductor substrate is a trained convolutional neural network (CNN) model present in the computer subsystem 801. The first instance of the machine learning model is a trained CNN based first inference module 804 present in the computer subsystem 801 and the second instance of the machine learning model is a trained CNN based second inference module 804 present in the computer subsystem 801. Each of the identified regions of interest is preprocessed individually and given as input to the respective inference modules 804 for defect detection against a background of the image in the respective regions of interest. As per present disclosure, the first ROI is preprocessed and given as input to the first inference module, where a first instance of the CNN model is applied on the first ROI for defect detection. Furthermore, the preprocessed image of the second ROI is provided as input into the second inference module for defect detection, where a second instance of the CNN model is applied on the second ROI for defect detection.

The processing circuitry is further configured to generate an object recognition result for defects in the identified ROIs by applying a distinct instance of the machine learning model wherein each of the instances of the machine learning model is trained to identify defects against a background of the image in the corresponding regions of interest. The machine learning models may be trained in a supervised method and may be performed offsite of where the inspection process is performed. The training may use a set of training images (e.g., one or more training images) with known defects present in each of the identified regions of interest. The training images may include different defects to train each of the instances of the machine learning model to identify different types of defects with different characteristics and intensities, present in the corresponding region of interest. After the machine learning model completes the training process, it can be used to generate an object recognition result to identify defects in each of the ROIs separately.

As per the present disclosure, the processing circuitry is configured to generate a first object recognition result for defects in the first ROI by applying a first instance of a machine learning model to the first ROI, the first instance of the machine learning model being trained to identify defects against a background of the image in the first ROI. Furthermore, the processing circuitry is configured to generate a second object recognition result for defects in the second ROI by applying a second instance of the machine learning model to the second ROI, the second instance of the machine learning model being trained to identify defects against a background of the image in the second ROI. In some embodiments, the processing circuitry is further configured to generate multiple object recognition results corresponding to each of the ROIs identified, by applying a distinct instance of the machine learning model to each of the ROIs, wherein each of the instances of the machine learning model is trained to identify unique defects against a background of the image in the corresponding regions of interest.

The processing circuitry is further configured to merge the first object recognition result that is output from the first inference module and the second object recognition result that is output from the second inference module. The merging of the first object recognition result and the second object recognition result comprises creating a compiled list of defects from the first object recognition result and the second object recognition result, which may represent a list of defect types and locations. Optionally, merging the lists may involve applying logic, including those types of logic described elsewhere herein. In some embodiments, the processing circuitry identifies multiple regions of interest and applies a distinct instance of the machine learning model to each of the regions of interest to generate an object recognition result for each of the ROIs. Furthermore, the object recognition results from each of these instances of the machine learning model are merged to generate a compiled list of defects. The merging of the object recognition results from different ROIs into a compiled list of defects, offers the advantage of standardization, thereby ensuring a consistent and unified representation of defects in the semiconductor substrate.

Further referring to FIG. 9, the processing circuitry is a part of a computer subsystem 801 that includes an inference model 804 where each instance of the machine learning model is applied to its corresponding region of interest. The first object recognition result and the second object recognition result obtained from the inference module 804, by applying first and second instances of the machine learning model (CNN model), is provided to a remote AI server 810. The computer subsystem 801 is communicatively coupled to the remote AI server 810 via a network 803, which is a part of a transmission circuitry of the apparatus 800. The remote AI server 810 is configured re-train each of the instances of the machine learning model using the defects identified in the respective regions of interest. The re-training of the machine learning models on the remote AI server, ensures that the models can continuously improve and adapt to new defect patterns, enhancing the accuracy of defect identification.

Performing inference locally as opposed to on the AI server 810 may be beneficial for reasons of speed. Images of semiconductor wafers and panels may be large, represented by large quantities of data. In a fabrication environment, throughput of wafers and panels is important as higher throughput corresponds to greater productivity and leads to the completion of a greater number of devices. Transmitting the large amounts of data associated with images of semiconductor wafers or panels to a remote server (e.g., 810) may meaningfully slow throughput in the fabrication facility. Thus, processing the images locally, for example using processing circuitry of the instrument and/or computer subsystem 801 with inference module 804 may provide higher throughput for the facility.

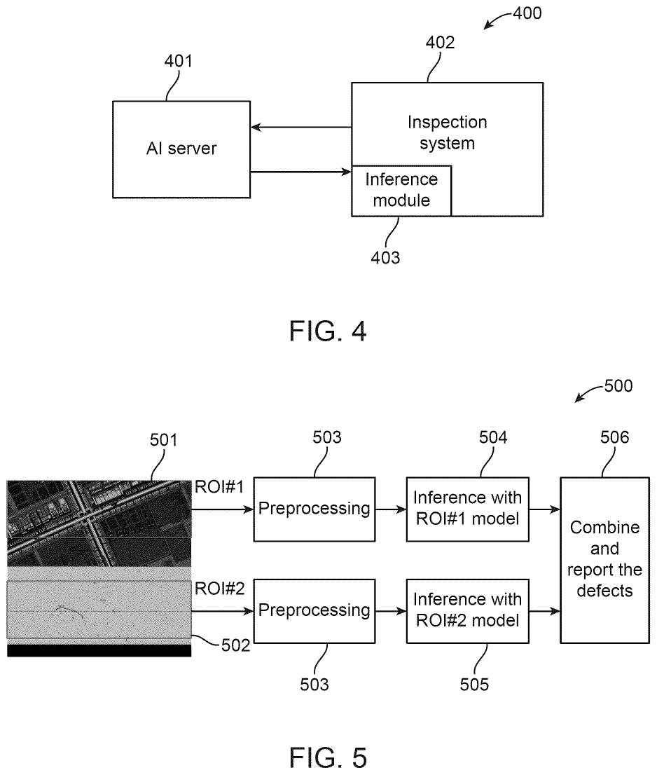

Additionally, referring to FIG. 4, the remote AI server 401 receives the first object recognition result from the inference module 403 on inspection system 402 over the network, where the AI server 401 re-trains the first instance of the machine learning model based on the identified defects from the first object recognition results. The remote AI server 401 adjusts its training parameters to match the current input obtained from the first object recognition result and re-trains the first instance of the machine learning model for optimized defect identification. Furthermore, the second object recognition result from the second region of interest is sent to the AI server 401 via the network, where the AI server 401 re-trains the second instance of the machine learning model based on the identified defects. The remote AI server 401 further adjusts its training parameters to match the second object recognition result and re-train the second instance of the machine learning model to accurately identify defects against a background of the image in the second ROI. In some embodiments, the AI server 401, re-trains multiple instances of the machine learning model using the object recognition result from the corresponding inference modules 403. In some embodiments, the inference module 403 may be a plugin inference module, that processes the image using a designated CNN-based model, ensuring real-time execution of these operations on inference module. The remote AI server reduces the need for manual intervention in the re-training process, which leads to more efficient use of resources and reduced downtime in the inspection workflow.

According to another aspect of the present disclosure, a computer readable storage medium storing processor-executable instructions configured to, when executed by at least one processor, cause performance of a method of processing an image of a semiconductor substrate to identify defects in the semiconductor substrate, is disclosed. The method comprising, receiving an image of a semiconductor substrate and identifying a first region of interest (ROI) and a second ROI of the image of the semiconductor substrate. The method as per the present disclosure further comprising, generating a first object recognition result for defects in the first ROI by applying a first instance of a machine learning model to the first ROI, the first instance of the machine learning model being trained to identify defects against a background of the image in the first ROI and generating a second object recognition result for defects in the second ROI by applying a second instance of the machine learning model to the second ROI, the second instance of the machine learning model being trained to identify defects against a background of the image in the second ROI. The method further comprising, merging the first object recognition result and the second object recognition result for generating a compiled list of defects identified on the semiconductor substrate.

As used herein, the phrase “computer readable storage medium” may include any medium that is capable of storing, encoding, or carrying instructions for execution by the processor and that cause the processor to perform any one or more of the techniques of the present disclosure, or that is capable of storing, encoding or carrying data structures used by or associated with such instructions. Non-limiting computer readable storage medium examples may include solid-state memories, and optical and magnetic media. Specific examples of massed computer readable storage medium may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The computer readable storage medium storing processor-executable instructions configured to, when executed by at least one processor, cause performance of a method of processing an image of a semiconductor substrate to identify defects in the semiconductor substrate, is disclosed. The method comprising, receiving an image of the semiconductor substrate to be inspected by the inspection tool, wherein the image of the semiconductor substrate is a target image. As present disclosure, the target image is generated by scaling a raw image of the semiconductor substrate of varying shapes, preferably from a rectangular shape to a square shape. The raw image of the semiconductor substrate, may be a high definition image captured by an imaging system present on the inspection tool having a pixel size less than 6 microns, less than 1 micron, less than 0.02 micron, or between 0.02 microns and 6 microns (e.g., 0.7 microns). In some embodiments, the image of the semiconductor substrate received by the inspection tool may be an Electron microscope image, an X-ray image, an optical or a thermal image, which provide a raw image of the semiconductor substrate for defect identification.

The method further comprises identifying a first region of interest (ROI) and a second ROI of the image of the semiconductor substrate. Identifying an ROI of the image of the semiconductor substrate may involve performing initial image analysis to highlight areas that deviate from expected patterns, focusing on anomalies or irregularities indicative of defects. As per the present disclosure, a first and second ROI is identified for an image of the semiconductor substrate to be inspected. In some embodiments, the first ROI and the second ROI identified on the semiconductor substrate, do not overlap. In alternative embodiments, the first ROI and the second ROI identified on the semiconductor substrate may overlap. In a non-limiting embodiment, the method of processing an image of a semiconductor substrate to identify defects may comprise of identifying multiple regions of interest of the image of the semiconductor substrate, which may or may not overlap with each other.

The computer readable storage medium storing processor-executable instructions configured to, when executed by at least one processor, cause performance of a method of processing an image of a semiconductor substrate to identify defects in the semiconductor substrate, further comprising, applying a first instance of a machine learning model to the first ROI for generating a first object recognition result for defects and applying a second instance of the machine learning model to the second ROI for generating a second object recognition result for defects. Furthermore, as per present disclosure, the first instance of the machine learning model is trained to identify defects against a background of the image in the first ROI and the second instance of the machine learning model is trained to identify defects against a background of the image in the second ROI. In some embodiments, the method comprises identifying multiple regions of interest and applying separate instances of machine learning models on each of the identified regions of interest.

The method for processing an image of a semiconductor substrate to identify defects employs a machine learning models such as a trained Convolutional Neural Network (CNN) model. The first instance of the machine learning model functions as the first inference model, while the second instance functions as the second inference model. As per present disclosure, the first ROI is preprocessed and input into the first inference model, where the first instance of the CNN is applied for defect detection. Similarly, the preprocessed image of the second ROI is provided as input to the second inference model, where the second instance of the CNN is used for defect detection. In some embodiments, the method comprises, applying multiple instances of the CNN model, to respective the multiple ROIs, for defect detection against a background of the image in the identified regions of interest.

The method executed by the computer readable storage medium, further comprising, generating a first object recognition result for defects in the first ROI by applying a first instance of a machine learning model to the first ROI and generating a second object recognition result for defects in the second ROI by applying a second instance of the machine learning model to the second ROI. The method further comprising, merging the first object recognition result and the second object recognition result to create a compiled list of defects. In some embodiments, the method identifies multiple regions of interest, which may include more than two regions of interest, and applies a distinct instance of the machine learning model to each of the regions of interest to generate an object recognition result for each of the ROIS. Furthermore, the object recognition results from each of these instances of the machine learning model are merged to generate a compiled list of defects.

As per the present disclosure, the first and second instances of the machine learning model are separately trained to identify defects specifically present in first and second regions of interest. Each of the instances of the machine learning model are specifically trained using a set of ROI images to identify defects specific to that particular region of interest. The first instance of the machine learning model is trained using first set of training images same as the first ROI to identify unique defects against a background of the image in the first ROI. Similarly, the second instance of the machine learning model is trained using a second set of training images same as the second ROI, to identify unique defects against a background of the image in the second ROI. In some embodiments, the method identifies multiple regions of interest and applies a distinct instance machine learning model to each of these regions of interest, wherein each of these instances of the machine learning model are individually trained to identify defects specific to its corresponding region of interest.

The computer readable storage medium as per the present disclosure, provides a tangible and practical implementation of the automated inspection method, making it easier to integrate into existing inspection systems. The computer readable storage medium ensures that the inspection method can be easily and consistently replicated across multiple inspection systems, leading to standardized quality control procedures. The processor-executable instructions provide the flexibility to update or modify the inspection method through software changes rather than hardware, allowing for rapid adaptation to new inspection requirements or improvements in inspection technology. Furthermore, the automation of the inspection process through the use of processor-executable instructions can significantly reduce the potential for human error, increase inspection speed, and enable continuous operation, which is critical for maintaining high production rates in semiconductor manufacturing.

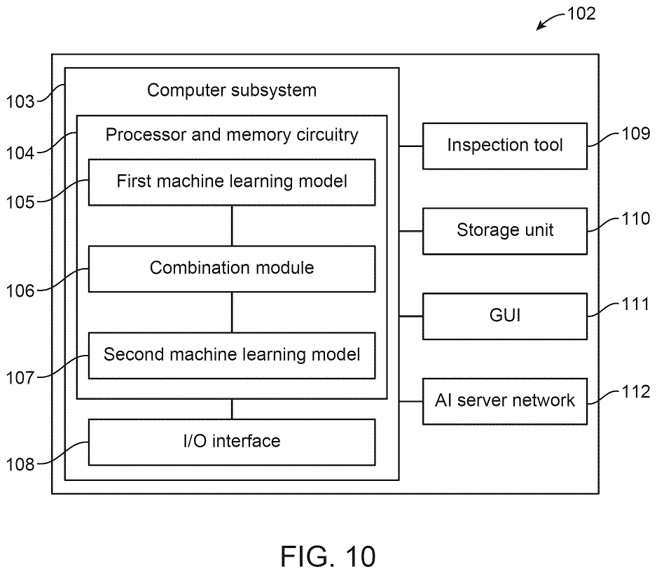

FIG. 10, illustrates an example system 102 that can be used in some embodiments. The system 102 can have a computer readable storage medium storing processor-executable instructions, which is further configured to execute the method of processing an image of a semiconductor substrate to identify defects in the semiconductor substrate. The method of processing an image of a semiconductor substrate to identify defects in the semiconductor substrate is implemented as computer subsystem 103. The processor and memory circuitry 104, executes the method to generate a first object recognition result for defects in the first ROI by applying a first instance of a machine learning model 105 to the first ROI and generate a second object recognition result for defects in the second ROI by applying a second instance of the machine learning model 107 to the second ROI. The first instance of a machine learning model 105 and second instance of the machine learning model 107 are trained CNN models, configured to identify defects unique to their respective ROIs. The first and second object recognition results from first machine learning model 105 and second machine learning model 107 is merged to create a compiled list of defects in a combination module 106.

The computer subsystem 103 can input and output using an I/O interface 108. The I/O interface 108 allows for communication between the computer subsystem 103 and other components and systems such as inspection tool 109, storage unit 110, graphical user interface (GUI) 111, and AI server network 112. The computer subsystem 103 is communicatively coupled to the remote AI server network 112, which is a part of a transmission circuitry of the apparatus 800. The remote AI server network 112 receives the first object recognition result from first instance of a machine learning model 105, where the AI server re-trains the first instance of the machine learning model based on the identified defects from the first object recognition results. Furthermore, the second object recognition result from first instance of a machine learning model 107 is sent to the AI server network 112, where the AI server re-trains the second instance of the machine learning model based on the identified defects. This enables the computer subsystem 103 to optimize the inspection process and reduce runtime errors.

Inspection tool 109 is a system for inspecting substrates for defects such as described in FIG. 9. The computer subsystem 103 can be used as computer subsystem 801. In some embodiments system 102 describes aspects of FIG. 9.

The computer subsystem 103 of FIG. 10, is configured to provide the functionality described herein. In embodiments, the computer subsystem 103 can be a server and/or other computing device that performs the operations discussed herein, such as the classifying defect operations as described herein. The computer subsystem 103 may include computing components. The computing components can include at least one processor circuitry and memory circuitry. The memory circuitry may include a non-transient computer readable medium. Depending on the exact configuration, the memory circuitry (storing, among other things, substrate yield prediction instructions and instructions to perform the other operations disclosed herein) may be a volatile memory (such as RAM), non-volatile (such as ROM, flash memory, etc.), or some combination thereof.

The memory circuitry may store one or more sets of data structures or instructions (e.g., software or firmware) embodying or utilized by any one or more of the techniques or functions described herein. The instructions may also reside, completely or at least partially, within a main memory, within a volatile memory, within a non-volatile memory, or within the hardware-based processor during execution thereof by the computer subsystem 103. In an example, one or any combination of the hardware-based processor, the main memory, the volatile memory, and the non-volatile memory may constitute computer-readable media. While the computer-readable medium is considered as a single medium, the term “computer-readable medium” may include a single medium or multiple media (e.g., a centralized or distributed database, and/or associated caches and servers) configured to store the one or more instructions.

Further, the computer subsystem 103 may also include storage unit 110 (removable, and/or non-removable) including, but not limited to, solid-state devices, magnetic or optical disks, or tape. Further, the computer subsystem 103 may also have graphical interface unit (GUI) 111 that includes a display. I/O interface 108 can comprise, input device(s) such as touch screens, keyboard, mouse, pen, voice input, etc., and/or output device(s) such as a display, speakers, printer, etc. One or more communication connections, such as local-area network (LAN), wide-area network (WAN), point-to-point, Bluetooth, RF, etc., may also be incorporated into the computer subsystem 103. Further, while only a single computer subsystem is illustrated, the term “computer subsystem” shall also be taken to include any collection of computer subsystems that individually or jointly execute a set (or multiple sets) of instructions to perform any one or more of the methodologies discussed herein, such as cloud computing, software as a service (Saas), or other computer cluster configurations.

According to an aspect of the present technology, a method is provided for processing an image of a semiconductor substrate to identify defects in the semiconductor substrate. The method comprises identifying multiple regions of interest (ROI) in the image of the semiconductor substrate, the multiple ROIs having respective backgrounds, and identifying a presence of a defect in one or more of the multiple ROIs by performing object recognition on the multiple ROIs using respective instances of a machine learning model trained on the respective backgrounds of the respective ROIS.

The method may further comprise generating a defect report listing defects in the semiconductor substrate based on the identification of the presence of defects in the one more of the multiple ROIS.

According to an aspect of the present technology, a computer readable storage medium is provided storing processor-executable instructions configured to, when executed by at least one processor, cause performance of a method of processing an image of a semiconductor substrate to identify defects in the semiconductor substrate. The method comprises identifying multiple regions of interest (ROI) in the image of the semiconductor substrate, the multiple ROIs having respective backgrounds, and identifying a presence of a defect in one or more of the multiple ROIs by performing object recognition on the multiple ROIs using respective instances of a machine learning model trained on the respective backgrounds of the respective ROIs. The method further comprises generating a defect report listing defects in the semiconductor substrate based on the identification of the presence of defects in the one more of the multiple ROIs.

According to an aspect of the present technology, an apparatus is provided for automated inspection of a semiconductor substrate, comprising: a stage for holding the semiconductor substrate; an imaging camera configured to capture an image of the semiconductor substrate; and processing circuitry configured to: identify multiple regions of interest (ROI) in the image of the semiconductor substrate, the multiple ROIs having respective backgrounds; and identify a presence of a defect in one or more of the multiple ROIs by performing object recognition on the multiple ROIs using respective instances of a machine learning model trained on the respective backgrounds of the respective ROIs. The processing circuitry is further configured to generate a defect report listing defects in the semiconductor substrate based on the identification of the presence of defects in the one more of the multiple ROIs.

The present method and system as disclosed herein, effectively enables the distinguishment between genuine defects and background noise, thereby minimizing errors, reducing false detection rates, and ultimately improve the efficiency and reliability of semiconductor fabrication processes.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

While some embodiments have been described as involving the identification and processing of two regions of interest, labeled as a first region of interest and second region of interest, it should be appreciated that the various embodiments are not limited to using two regions of interest but instead may involve identifying and processing more than two regions of interest.

1. A method of processing an image of a semiconductor substrate to identify defects in the semiconductor substrate, comprising:
receiving an image of at least a portion of the semiconductor substrate;
identifying a first region of interest (ROI) and a second ROI of the image of the at least a portion of the semiconductor substrate;
generating a first object recognition result for defects in the first ROI by applying a first instance of a machine learning model to the first ROI, the first instance of the machine learning model being trained to identify defects against a background of the image in the first ROI;
generating a second object recognition result for defects in the second ROI by applying a second instance of the machine learning model to the second ROI, the second instance of the machine learning model being trained to identify defects against a background of the image in the second ROI; and
merging the first object recognition result and the second object recognition result.

2. The method of claim 1, wherein the machine learning model is a convolutional neural network.

3. The method of claim 1, or wherein merging the first object recognition result and the second object recognition result comprises creating a compiled list of defects from the first object recognition result and the second object recognition result.

4. The method of claim 1, wherein the first ROI and the second ROI do not overlap.

5. The method of claim 1, wherein the first ROI and the second ROI overlap.

6. The method of claim 1, wherein the image of the semiconductor substrate is a target image, and wherein the method further comprises generating the target image by scaling a raw image of the semiconductor substrate from a rectangular shape to a square shape.

7. The method of claim 1, further comprising providing the first object recognition result and the second object recognition result to a remote server configured to re-train the first instance of the machine learning model and the second instance of the machine learning model.

8. The method of claim 1, wherein the image of the semiconductor substrate has a pixel size less than 6 microns.

9. A computer readable storage medium storing processor-executable instructions configured to, when executed by at least one processor, cause performance of a method of processing an image of a semiconductor substrate to identify defects in the semiconductor substrate, the method comprising:
receiving the image of the semiconductor substrate;
identifying a first region of interest (ROI) and a second ROI of the image of the semiconductor substrate;
generating a first object recognition result for defects in the first ROI by applying a first instance of a machine learning model to the first ROI, the first instance of the machine learning model being trained to identify defects against a background of the image in the first ROI;
generating a second object recognition result for defects in the second ROI by applying a second instance of the machine learning model to the second ROI, the second instance of the machine learning model being trained to identify defects against a background of the image in the second ROI; and
merging the first object recognition result and the second object recognition result.

10. The computer readable storage medium of claim 9, wherein the machine learning model is a convolutional neural network.

11. The computer readable storage medium of claim 9, wherein merging the first object recognition result and the second object recognition result comprises creating a compiled list of defects from the first object recognition result and the second object recognition result.

12. The computer readable storage medium of claim 9, wherein the first ROI and the second ROI do not overlap.

13. The computer readable storage medium of claim 9, herein, wherein the first ROI and the second ROI overlap.

14. The computer readable storage medium of claim 9, wherein the image of the semiconductor substrate is a target image, and wherein the processor-executable instructions are further configured to cause performance of the method to further comprise generating the target image by scaling a raw image of the semiconductor substrate from a rectangular shape to a square shape.

15. The computer readable storage medium of claim 9, wherein the processor-executable instructions are further configured to cause the performance of the method to further comprise providing the first object recognition result and the second object recognition result to a remote server configured to re-train the first instance of the machine learning model and the second instance of the machine learning model.

16. The computer readable storage medium of claim 9, wherein the image of the semiconductor substrate has a pixel size less than 6 microns.

17. An apparatus for automated inspection of a semiconductor substrate, comprising:
a stage for holding the semiconductor substrate;
an imaging camera configured to capture an image of the semiconductor substrate; and
processing circuitry configured to:
receive the image of the semiconductor substrate;
identify a first region of interest (ROI) and a second ROI of the image of the semiconductor substrate;
generate a first object recognition result for defects in the first ROI by applying a first instance of a machine learning model to the first ROI, the first instance of the machine learning model being trained to identify defects against a background of the image in the first ROI;
generate a second object recognition result for defects in the second ROI by applying a second instance of the machine learning model to the second ROI, the second instance of the machine learning model being trained to identify defects against a background of the image in the second ROI; and
merge the first object recognition result and the second object recognition result.

18. The apparatus of claim 17, wherein the machine learning model is a convolutional neural network.

19. The apparatus of claim 17, wherein the processing circuitry is configured to merge the first object recognition result and the second object recognition result at least in part by creating a compiled list of defects from the first object recognition result and the second object recognition result.

20. The apparatus of claim 17, wherein the first ROI and the second ROI do not overlap.

21. The apparatus of claim 17, wherein the first ROI and the second ROI overlap.

22. The apparatus of claim 17, wherein the processing circuitry is further configured to scale the image of the semiconductor substrate from a rectangular shape to a square shape prior to generating the first object recognition result and the second object recognition result.

23. The apparatus of claim 17, further comprising transmission circuitry configured to provide the first object recognition result and the second object recognition result to a remote server configured to re-train the first instance of the machine learning model and the second instance of the machine learning model.

24. The apparatus of claim 17, wherein the image of the semiconductor substrate has a pixel size less than 6 microns.
